(19) United States
(12) Patent Application Publication
(10) Pub. No.: US 2011/0085046 A1
(43) Pub. Date: Apr. 14, 2011

(54) DATA COMMUNICATION METHOD AND SYSTEM USING MOBILE TERMINAL

(75) Inventor: Kwang Min SEO, Yongin-si (KR)

(73) Assignee: SAMSUNG ELECTRONICS CO. LTD., Suwon-si (KR)

(21) Appl. No.: 12/894,708

(22) Filed: Sep. 30, 2010

(30) Foreign Application Priority Data
Oct. 14, 2009 (KR) 10-2009-0097924

(51) Int. Cl. H04N 5/225

(52) U.S. Cl. 348/207.1; 348/E05.024

(57) ABSTRACT

A data communication method and system using a mobile terminal are provided. Multimedia data stored in a mobile terminal can be provided to a counterpart during webcam communication. The data communication method includes activating webcam mode operation, identifying a preset operating mode during the webcam mode operation, the preset operating mode being selected from a plurality of operating modes including a multimedia mode and a capture mode, extracting, when the preset operating mode is the multimedia mode, multimedia data according to a predetermined acquisition scheme, and transmitting the extracted multimedia data to a connected device through a pre-specified interface.

### PRIORITY

This application claims the benefit under 35 U.S.C. §119(a) of a Korean patent application filed on Oct. 14, 2009 in the Korean Intellectual Property Office and assigned Serial No. 10-2009-0097924, the entire disclosure of which is hereby incorporated by reference.

### BACKGROUND OF THE INVENTION

1. Field of the Invention:

The present invention relates to data communication using a mobile terminal. More particularly, the present invention relates to a method and system for data communication that enable a mobile terminal having a webcam to transmit stored multimedia data to an external device while the mobile terminal operates in the webcam mode.

2. Description of the Related Art:

With rapid advances in electronics technology, mobile terminals are being equipped with increasingly diverse functions. For example, modern mobile terminals may provide a wireless Internet access function for web-surfing, an MP3 playback function for music listening, or a digital camera function for image capture. In particular, a high-end mobile terminal may provide the wireless Internet access function, the MP3 playback function and the digital camera function.

A mobile terminal may be connected to an external device such as a Personal Computer (PC) or laptop computer through a preset interface to interwork with the device. For example, the mobile terminal may provide a webcam capability in cooperation with the connected device. Here, “webcam” is a combination of the words “web” and “camera”.

A conventional webcam is a camera module or digital camera connected to a device such as a PC or laptop, and is controlled by a particular application running on the device. For example, the webcam acts as a camera of a device in a video chat or video call service provided using a messenger program running on the device or using the Web. Next, a brief description will be given of a webcam system including a mobile terminal and a device.

A conventional webcam system includes a device such as a PC or laptop, a mobile terminal having a camera module, and a data cable connecting the device and the mobile terminal.

The device includes a data port connectable to the data cable (such as a Universal Serial Bus (USB) port or IEEE1394 port), and a video chat application or a video call application. The data cable is a medium connecting the device and the mobile terminal, and may be a USB cable or an IEEE1394 cable. The mobile terminal includes a camera module and a data port connectable to the data cable (such as a USB port or IEEE1394 port).

In the webcam system, the data port of the mobile terminal is connected through the data cable to the data port of the device. The webcam system runs a messenger application on the device to provide a video chat or video call service based on the camera module of the mobile terminal.

The mobile terminal may create and store various types of multimedia data including music data, photographs and moving images. However, in spite of such a multimedia capability of the mobile terminal, during a video chat or a video call, the existing webcam system tends to transmit only moving images captured by the camera module of the mobile terminal to the counterpart. That is, in the existing webcam system, a video chat or a video call service transmits only moving images captured by the camera module of the mobile terminal, and fails to provide a mechanism that enables multimedia data stored in the mobile terminal to be shared with or transmitted to the counterpart.

### SUMMARY OF THE INVENTION

An aspect of the present invention is to address the above-mentioned problems and/or disadvantages and to provide at least the advantages described below. Accordingly, an aspect of the present invention is to provide a method and system for data communication using a mobile terminal having a webcam capability.

An aspect of the present invention is to provide a method and system for data communication using a mobile terminal wherein the mobile terminal may transmit various multimedia data in the webcam mode.

Another aspect of the present invention is to provide a method and system that enable the user to easily connect a mobile terminal having a camera module to a device through a wired or wireless communication scheme for effective webcam communication.

Yet another aspect of the present invention is to provide a method and system that enable the user to transmit multimedia data stored in a mobile terminal to the counterpart when the mobile terminal is used as a webcam.

Still another aspect of the present invention is to provide a method and system for data communication wherein a mobile terminal having a webcam capability may transmit stored multimedia data including moving images, photographs, music data, broadcast data, mail data and menu data through webcam communication.

Another aspect of the present invention is to provide a method and system for data communication wherein a mobile terminal having a webcam capability may make a mode transition between the capture mode for transmitting captured image data and the multimedia mode for transmitting multimedia data during webcam communication.

In accordance with an aspect of the present invention, a data communication method using a mobile terminal is provided. The method includes activating webcam mode operation, identifying a preset operating mode during webcam mode operation, extracting, when the preset operating mode is the multimedia mode, multimedia data according to a preset acquisition scheme, and transmitting the extracted multimedia data to a connected device through a pre-specified interface.

In accordance with another aspect of the present invention, a mobile terminal is provided. The terminal includes a camera module capturing image data in webcam mode operation, a storage unit storing multimedia data and mode information for webcam mode operation, an interface unit transmitting one of captured image data using a data path from the camera module and multimedia data using a data path from the storage unit to an external device, and a control unit controlling a process of activating webcam mode operation, identifying an operating mode during webcam mode operation, setting up, when the operating mode is the multimedia mode, a data path from the storage unit, and transmitting multimedia data stored in the storage unit to the device through the interface unit.

In accordance with yet another aspect of the present invention, a webcam communication system is provided. The system includes a mobile terminal having a camera module, and transmitting one of image data captured by the camera module and stored multimedia data through a specified interface according to an identified operating mode during webcam mode operation, a first device connected to the mobile terminal through the specified interface, and forwarding the captured image data or multimedia data received from the mobile terminal, and a second device performing webcam communication with the first device through the Internet, receiving the captured image data or multimedia data from the first device, and providing the received data to a user thereof.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a sequence diagram illustrating data transmission during a video chat involving a mobile terminal and external devices according to an exemplary embodiment of the present invention;

FIG. 2 is a flowchart illustrating a data communication method for a mobile terminal operating in the webcam mode according to an exemplary embodiment of the present invention;

FIG. 3 is a flowchart illustrating a procedure for the mobile terminal to extract multimedia data in the webcam mode according to an exemplary embodiment of the present invention;

FIG. 4 is a block diagram of a mobile terminal according to an exemplary embodiment of the present invention; and

FIG. 5 illustrates a webcam communication system using a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention relates to a mobile terminal having a camera module. Embodiments of the present invention relate to a method and system that provide a webcam service using the mobile terminal connected to an external device such as a Personal Computer (PC) or laptop. In particular, the present invention provides a method and system for data communication between the mobile terminal and the device in a webcam service.

In accordance with an exemplary embodiment of the present invention, webcam communication including a video chat and video call may be performed between the mobile terminal and the device. During webcam communication, the mobile terminal may send image data captured by the camera module and stored multimedia data to the device, and receive multimedia data through the device from the corresponding mobile terminal. That is, pre-stored multimedia data including moving images, photographs, music data, broadcast data, menu data, mail data and message data may be transmitted and received during webcam communication.

In accordance with an exemplary embodiment of the present invention, during webcam communication, not only live image data captured by the camera module of the mobile terminal but also multimedia data pre-stored in the mobile terminal may be transmitted to the counterpart. Next, a description is given of a method and system that enable transmission of multimedia data during webcam communication using the mobile terminal.

In accordance with an exemplary embodiment of the present invention, the mobile terminal supports at least one of a wired communication interface and a wireless communication interface to transmit multimedia data to the device. Hence, the mobile terminal may be connected to the device through a wired communication interface or a wireless communication interface depending upon agreement. In an exemplary embodiment, the mobile terminal may send multimedia data through the communication interface to the device, which may then send the received multimedia data to a corresponding device through the Web (i.e., the Internet).

In accordance with an exemplary embodiment of the present invention, the mobile terminal may be connected to the device through a wireless communication scheme based on wireless Personal Area Network (PAN) technology, or through a wired communication scheme based on Universal Serial Bus (USB), IEEE1394, FireWire or i.Link serial bus technology.

A PAN refers to a short-range network connecting various appliances in proximity to an individual. In an exemplary implementation, the mobile terminal may be connected to the device through a wireless personal area network based on Infrared Data Association (IrDA), Bluetooth, Ultra Wideband (UWB), ZigBee or Wi-Fi technology.

As described above, the mobile terminal may be connected to the device through an agreed interface scheme. The mobile terminal provides various stored multimedia data to the device through a communication interface supporting the agreed interface scheme. Then, the device forwards the received multimedia data to the counterpart of webcam communication. Unlike an existing terminal-based webcam service in which only image data captured by the camera module is transmitted, the present invention may provide various types of video chat services by transmitting various multimedia data stored in the mobile terminal, overcoming limitations of the existing webcam service.

An exemplary control system of the present invention may include a mobile terminal, a device running a messenger application for webcam communication using the mobile terminal as a webcam, a communication interface between the mobile terminal and the device, and an interface unit supporting the communication interface. As described before, the communication interface may be a wired interface or a wireless interface. Each of the mobile terminal and the device may include an interface unit supporting the specified communication interface.

Hereinafter, a description is given of a mobile terminal, and a method and system for controlling transmission of multimedia data between the mobile terminal and an external device. However, the present invention is not limited to or by the following description, and various changes and modifications are possible on the basis of the following description.

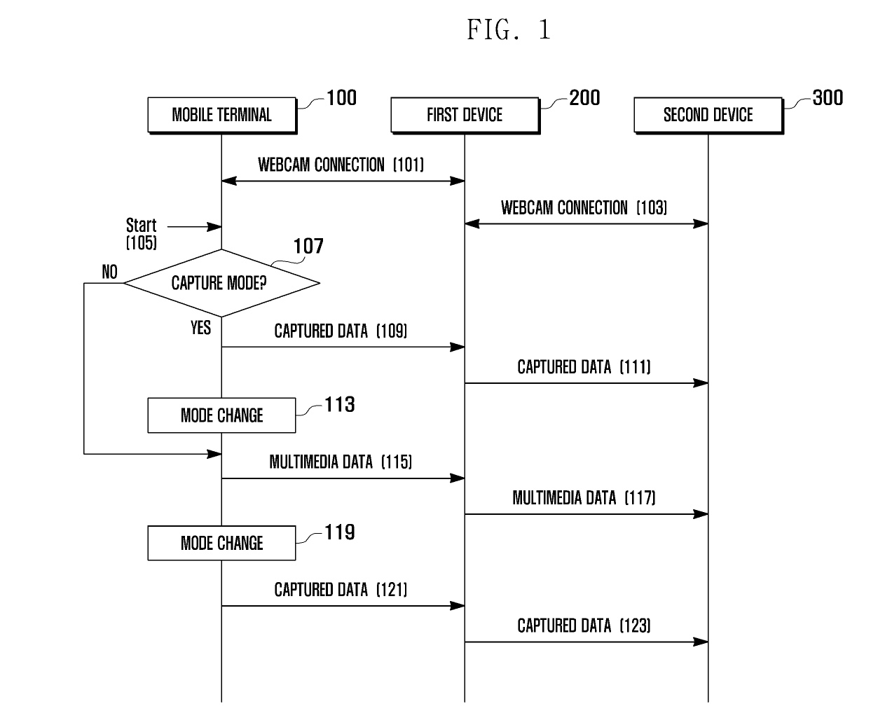

FIG. 1 is a sequence diagram illustrating data transmission during a video chat involving a mobile terminal and external devices according to an exemplary embodiment of the present invention.

Referring to FIG. 1, a mobile terminal 100 has a camera module and acts as a webcam in cooperation with a first device 200. The first device 200 may be a PC or laptop, and runs a webcam application using the mobile terminal 100 as a webcam to provide a webcam communication service in cooperation with a second device 300 through the Internet Protocol network. The mobile terminal 100 is connected to the first device 200 through an agreed communication interface. The second device 300 may be a PC or laptop, and runs a webcam application using a mobile terminal as a webcam or using a separate webcam to provide a webcam communication service in cooperation with the first device 200 through the Internet Protocol network.

Each of the mobile terminal 100 and the first device 200 may include a transceiver module using at least one of a wired communication scheme and a wireless communication scheme. The mobile terminal 100 may send image data captured by the camera module and stored multimedia data to the first device 200 using a selected communication scheme. Each of the first device 200 and the second device 300 may display data (captured image data and/or multimedia data) originating from the mobile terminal 100 on a display means using a specific application, and may use the data for webcam communication.

Referring to FIG. 1, in response to a webcam communication request from the user, the mobile terminal 100 transitions to the webcam mode and establishes a webcam connection to the first device 200 at step 101. In the webcam mode, the mobile terminal 100 and the first device 200 are connected through a specified communication interface, and the mobile terminal 100 prepares webcam operation. The communication interface may be one of a wired interface and a wireless interface, and each of the mobile terminal 100 and the first device 200 includes an interface unit supporting the specified communication interface. According to user settings, at step 101, the mobile terminal 100 may establish a webcam connection to the first device 200 without transitioning to the webcam mode.

The first device 200 establishes a webcam connection for a video chat or video call to the second device 300 through the Internet Protocol network at step 103. At step 103, each of the first device 200 and the second device 300 runs a messenger application and performs a login and authentication procedure.

After establishing the webcam connection between the first device 200 and the second device 300, the mobile terminal 100 begins to operate as a webcam at step 105. The mobile terminal 100 may receive a start command signal from the user or from the first device 200.

The mobile terminal 100 activates the webcam function and determines the operating mode set for webcam communication at step 107. Here, the operating mode may be one of the capture mode and multimedia mode. In the capture mode, image data of a target object captured by the camera module is transmitted. In the multimedia mode, stored multimedia data including moving images, photographs, music data, broadcast data, menu data, mail data and message data is transmitted.

If it is determined at step 107 that the operating mode is set to the capture mode, the mobile terminal 100 captures the image of a target object (for example, the user) through the camera module and transmits the captured image data to the first device 200 at step 109. The second device 300 receives the captured image data from the mobile terminal 100 and forwards the captured image data to the second device 300 through the Internet Protocol (IP) network at step 111.

Although not shown, the first device 200 may receive captured image data or multimedia data from the second device 300 and display the received data on a display means. The first device 200 may send and receive audio data and/or text data for webcam communication to and from the second device 300. Transmission of captured image data, audio data, and text data for webcam communication between the first device 200 and the second device 300, and presentation thereof are known to those skilled in the art, and hence a detailed description thereof is omitted.

Thereafter, the mobile terminal 100 may detect a mode change signal during capture mode operation at step 113. A mode change may occur from the capture mode to the multimedia mode. The mode change signal may be generated by the user of the mobile terminal 100 (for example, turning off the camera module, and entering a function key related to mode change), or by setting a mode change option in the application running on the first device 200.

When a mode change signal is detected at step 113 or the operating mode is determined to be the multimedia mode at step 107, the mobile terminal 100 stops image capture of the camera module and sends multimedia data stored in the storage means to the first device 200 at step 115. Here, the multimedia data may be one of data pre-selected by default, data randomly selected by the mobile terminal 100, and data explicitly selected by the user. The first device 200 receives the multimedia data from the mobile terminal 100 and forwards the same to the second device 300 through the Internet Protocol network at step 117. The mobile terminal 100 may turn off the camera module when transitioning from the capture mode to the multimedia mode.

Thereafter, the mobile terminal 100 may detect a mode change signal during multimedia mode operation at step 119. A mode change may occur from the multimedia mode to the capture mode. The mode change signal may be generated by the user of the mobile terminal 100 (for example, by turning on the camera module, and entering a function key related to mode change), or by setting a mode change option in the application running on the first device 200.

When a mode change signal is detected at step 119, the mobile terminal 100 captures the image of a target object (for example, the user) through the camera module and transmits the captured image data to the first device 200 at step 121. The second device 300 receives the captured image data from the mobile terminal 100 and forwards the captured image data to the second device 300 through the Internet Protocol network at step 123. The mobile terminal 100 may need to turn on the camera module when transitioning from the multimedia mode to the capture mode.

As described above, in the present invention, during webcam communication, the mobile terminal may transmit not only image data captured by the camera module but also stored multimedia data. The multimedia data may include all types of data that may be stored, created, played back, or executed by the mobile terminal, such as moving images, photographs, music data, broadcast data, menu data, mail data and message data. Such multimedia data may be provided to the counterpart according to the above procedure. Hence, the user of the mobile terminal may share various multimedia data stored in the mobile terminal with the counterpart in real time during webcam communication.

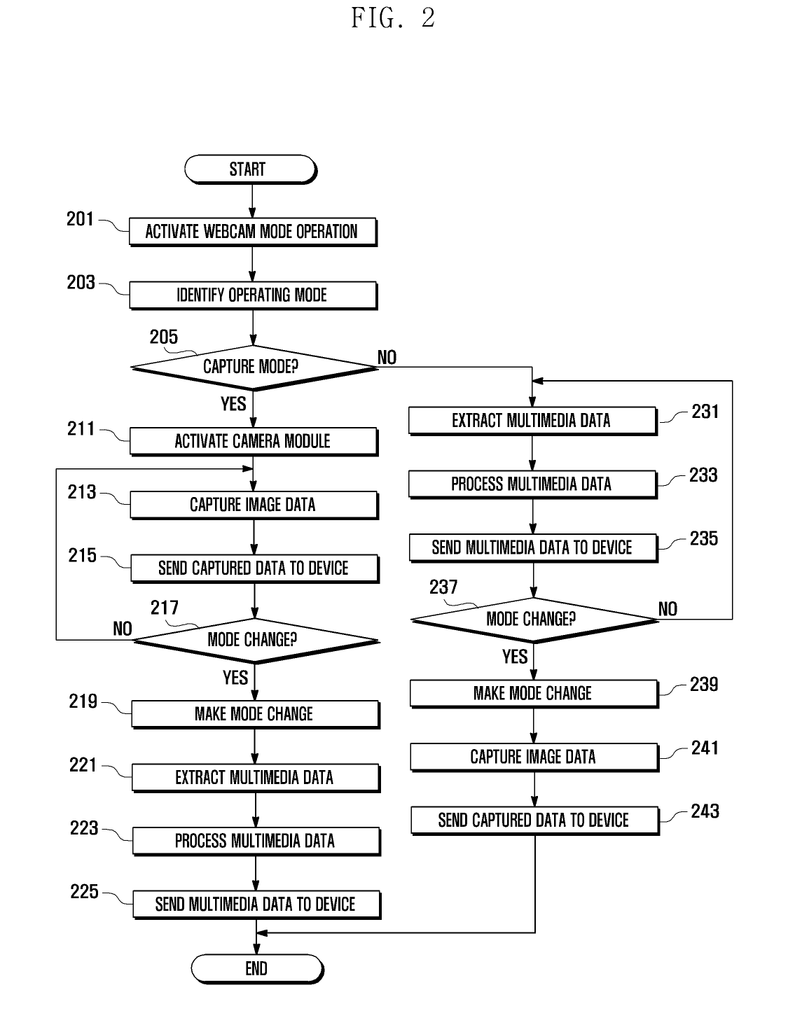

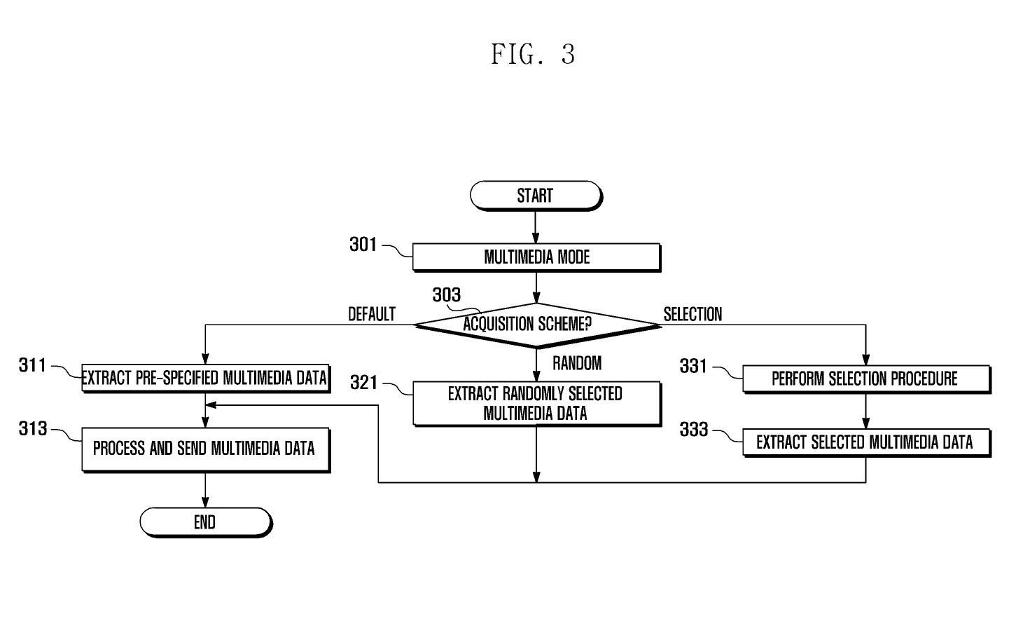

Next, a description is given of a control method for multimedia data transmission by the mobile terminal 100 in connection with FIGS. 2 and 3. However, the control method is not limited to or by the following description, and various changes and modifications are possible on the basis of the following description.

FIG. 2 is a flowchart illustrating a data communication method for the mobile terminal 100 operating in the webcam mode according to an exemplary embodiment of the present invention.

Referring to FIG. 2, the mobile terminal 100 activates the webcam mode at step 201. The webcam mode may be activated when the mobile terminal 100 starts to operate as a webcam in cooperation with a connected device, a webcam application is run on the connected device and synchronization is achieved, a user command is issued by an option set in the webcam application running on the connected device, or the user of the mobile terminal 100 makes a webcam request.

The mobile terminal 100 identifies the operating mode set for webcam communication at step 203. Here, the operating mode may be one of the capture mode and multimedia mode. The mobile terminal 100 determines whether the operating mode is set to the capture mode at step 205. In the capture mode, image data of a target object captured by the camera module is transmitted. In the multimedia mode, stored multimedia data including moving images, photographs, music data and broadcast data is transmitted.

When the operating mode is set to the capture mode, the mobile terminal 100 activates the camera module at step 211, captures image data using the camera module at step 213 and sends the captured image data to the device through a preset communication interface at step 215.

Thereafter, the mobile terminal 100 determines whether a mode change signal is received during capture mode operation at step 217. At this time, a mode change may occur from the capture mode to the multimedia mode. A mode change signal may be generated by user manipulation of the mobile terminal 100, or by setting a mode change option in the application running on the device.

If it is determined at step 217 that a mode change signal is not received, the mobile terminal 100 returns to step 213 and continues to transmit captured image data. On the other hand, if it is determined at step 217 that a mode change signal is received, the mobile terminal 100 transitions from the capture mode to the multimedia mode at step 219. The mobile terminal 100 may turn off the camera module according to settings when transitioning from the capture mode to the multimedia mode. When the camera module continues to be operated in the multimedia mode, the captured image data is not transmitted to the device. That is, in the mobile terminal, the data path from the camera module to the interface unit may be replaced by the data path from the storage means to the interface unit.

In the multimedia mode, the mobile terminal 100 extracts multimedia data to be sent at step 221. Here, the multimedia data may be one of data pre-selected by default, data randomly selected by the mobile terminal 100, and data explicitly selected by the user, from various multimedia data stored in the storage means. This is described further in connection with FIG. 3.

The mobile terminal 100 processes the extracted multimedia data at step 223, and sends the processed multimedia data to the device at step 225. At step 223, the extracted multimedia data is converted into a format suitable for transmission.

More specifically, at steps 223 and 225, the mobile terminal 100 may decode the extracted multimedia data to play back the decoded multimedia data, and re-encode the decoded multimedia data in a streaming format and transmit the re-encoded multimedia data to the device. Here, playback of the decoded multimedia data may or may not entail actual display thereof on the display means of the mobile terminal 100. The mobile terminal 100 may buffer the multimedia data being played back, encode the buffered multimedia data into transmit data suitable for transmission (for example, YUV data), and stream the transmit data to the device through the specified interface.

The device receives the transmit data and may send the transmit data through the Internet Protocol network to the counterpart device in webcam communication. Alternatively, the device may convert the transmit data into a format suitable for Internet transmission and send the converted transmit data to the counterpart device in webcam communication.

When the operating mode is set to the multimedia mode at step 205, the mobile terminal 100 extracts multimedia data to be sent at step 231. Here, the multimedia data may be one of data pre-selected by default, data randomly selected by the mobile terminal 100, and data explicitly selected by the user, from various multimedia data stored in the storage means. This is described further in connection with FIG. 3.

The mobile terminal 100 processes the extracted multimedia data at step 233, and sends the processed multimedia data to the device at step 235. At step 233, the extracted multimedia data is converted to a format suitable for transmission.

More specifically, at steps 233 and 235, the mobile terminal 100 may decode the extracted multimedia data to play back the decoded multimedia data, and re-encode the decoded multimedia data and transmit the recoded multimedia data in a streaming format to the device. Here, playback of the decoded multimedia data may or may not entail actual display thereof on the display means of the mobile terminal 100. The mobile terminal 100 may buffer the multimedia data being played back, encode the buffered multimedia data into transmit data suitable for transmission, and send the transmit data in a streaming format to the device through the specified interface.

The device receives the transmit data and may send the transmit data through the Internet Protocol network to the counterpart device in webcam communication. Alternatively, the device may convert the transmit data to a format suitable for Internet transmission and send the converted transmit data to the counterpart device in webcam communication.

Thereafter, the mobile terminal 100 determines whether a mode change signal is received during multimedia mode operation at step 237. At this time, a mode change may occur from the multimedia mode to the capture mode. A mode change signal may be generated by user manipulation of the mobile terminal 100, or by setting a mode change option in the application running on the device.

If it is determined at step 237 that a mode change signal is not received, the mobile terminal 100 returns to step 231 and continues to transmit stored multimedia data. On the other hand, if it is determined at step 237 that a mode change signal is received, the mobile terminal 100 transitions from the multimedia mode to the capture mode at step 239. The mobile terminal 100 stops extraction of multimedia data and may turn on the camera module when transitioning from the multimedia mode to the capture mode. That is, the camera module may have remained in the off state from the beginning, or have been turned off at the earlier mode change from the capture mode to the multimedia mode.

The mobile terminal 100 captures image data using the camera module at step 241, and sends the captured image data to the device through the preset communication interface at step 243.

FIG. 3 is a flowchart illustrating a procedure for the mobile terminal 100 to extract multimedia data to be sent in webcam mode operation according to an exemplary embodiment of the present invention.

Referring to FIG. 3, when the operating mode for webcam communication is set to the multimedia mode at step 301, the mobile terminal 100 determines the acquisition scheme for multimedia data to be sent in the multimedia mode at step 303. Here, the acquisition scheme may be set to one of “default”, “random”, and “selection”. In the “default” scheme, multimedia data that is selected by default (i.e. pre-specified by the user) is transmitted to the connected device. In the “random” scheme, randomly selected multimedia data is transmitted to the connected device. In the “selection” scheme, multimedia data explicitly selected by the user is transmitted to the connected device.

If it is determined at step 303 that the acquisition scheme is set to “default”, the mobile terminal 100 extracts the multimedia data pre-specified by the user at step 311. The mobile terminal 100 may maintain the access path to the pre-specified multimedia data as setting information, and the access path may be composed of path data and filename data in the storage means. The mobile terminal 100 processes the extracted multimedia data and sends the processed multimedia data to the device at step 313.

If it is determined at step 303 that the acquisition scheme is set to “random”, the mobile terminal 100 randomly extracts multimedia data from various multimedia data stored in the storage means at step 321. The mobile terminal 100 processes the extracted multimedia data and sends the processed multimedia data to the device at step 313.

If it is determined at step 303 that the acquisition scheme is set to “selection”, the mobile terminal 100 invokes a selection procedure requesting that the user select desired multimedia data at step 331. The selection procedure may provide a list of selectable multimedia data. The mobile terminal 100 extracts multimedia data that is selected by the user through the selection procedure at step 333. The mobile terminal 100 processes the extracted multimedia data and sends the processed multimedia data to the device at step 313.

Next, a description is given of the configuration of the mobile terminal 100. However, the configuration of the mobile terminal 100 is not limited to or by the following description, and various changes and modifications are possible on the basis of the following description.

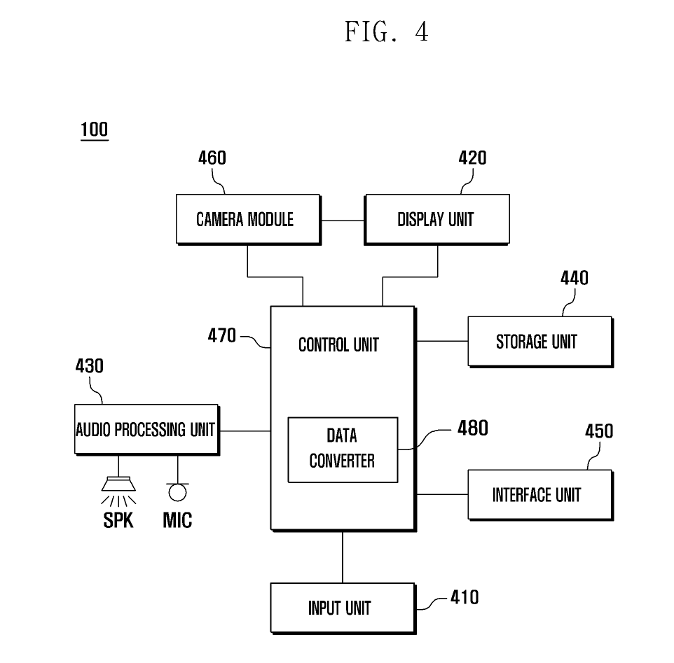

FIG. 4 is a block diagram of the mobile terminal 100 according to an exemplary embodiment of the present invention.

Referring to FIG. 4, the mobile terminal 100 includes an input unit 410, a display unit 420, an audio processing unit 430, a storage unit 440, an interface unit 450, a camera module 460, and a control unit 470. The audio processing unit 430 includes a speaker SPK and a microphone MIC, and the control unit 470 includes a data converter 480. Next, each component of the mobile terminal 100 will be described in greater detail.

The input unit 410 transmits key signals from the user for inputting alphanumeric information and setting and controlling various functions of the mobile terminal 100 to the control unit 470. The input unit 410 includes a plurality of alphanumeric and function keys for generating input signals. The function keys may include direction, side, and shortcut keys associated with corresponding functions. The input unit 410 may include one or more of a touch pad, a touch screen, and a keypad (regular or qwerty) according to the design. In particular, the input unit 410 may generate an input signal for determining the operating mode during webcam operation and send the input signal to the control unit 470.

The display unit 420 displays a screen related to a function execution of the mobile terminal 100. For example, the display unit 420 may display a boot screen, an idle screen, a menu screen, a call handling screen, and a webcam operation screen. That is, the display unit 420 may display screens related to various states and operations of the mobile terminal 100. The display unit 420 may be realized using Liquid Crystal Display (LCD) devices or Organic Light Emitting Diodes (OLED). When the display unit 420 has a touch screen capability, it may be combined with the function of the input unit 410 to act as an input/output means. When the mobile terminal 100 operates as a webcam, the display unit 420 may be turned off or remain active to display a webcam operation screen, multimedia playback screen, or a list of multimedia data.

The audio processing unit 430 may include a speaker SPK for reproducing an audio signal, and a microphone MIC for collecting an audio signal such as a voice signal. The audio processing unit 430 is connected to the microphone MIC and speaker SPK. The audio processing unit 430 converts a voice signal from the microphone MIC into data and sends the data to the control unit 160, and outputs an audio signal from the control unit 470 through the speaker SPK. That is, the audio processing unit 430 converts an analog voice signal from the microphone MIC into a digital audio signal and sends the digital audio signal to the control unit 470, and converts a digital audio signal from the control unit 470 into an analog audio signal and outputs the analog audio signal through the speaker SPK.

The audio processing unit 430 may reproduce various audio content generated by the mobile terminal 100 (for example, an audio signal generated in the course of receiving a webcam communication service) according to user selection. When the mobile terminal 100 operates as a webcam, the audio processing unit 430 collects a voice signal from the user through the microphone MIC and sends the voice signal to the control unit 470, and receives an audio signal delivered from the device under the control of the control unit 470 and outputs the audio signal through the speaker SPK. That is, the mobile terminal 100 may assume the role of a microphone and speaker for webcam communication through the audio processing unit 430, the microphone MIC and the speaker SPK. Accordingly, the mobile terminal 100 may assume the role of multiple input and output means for webcam communication, such as a webcam for video input and components for audio input and output, as a single entity.

The storage unit 440 may include a Read Only Memory (ROM) (not shown) and/or Random Access Memory (RAM) (not shown), and stores various data created and used in the mobile terminal 100. The data may include data generated in the course of function execution of the mobile terminal 100 (for example, photographs, moving images, broadcast data, music data, menu data, mail data and message data), data created by the mobile terminal 100 or received from external devices (for example, a counterpart mobile terminal and PC), and applications related to functions and menus of the mobile terminal 100. The storage unit 440 may store data necessary for data communication through the interface unit 450, and various setting information for the operation of the mobile terminal 100 (for example, operating mode information).

The storage unit 440 may provide one or more buffers to temporarily store data generated in the course of operation of the mobile terminal 100. For example, the storage unit 440 may buffer a preset amount of multimedia data sent and received through the interface unit 450. The storage unit 440 may also buffer a preset amount of image data captured by the camera module 460.

The storage unit 440 may include internal storage media and external storage media such as a smart card. The storage unit 150 may include a ROM, RAM, flash memory, and a combination thereof such as a multi-chip package.

The interface unit 450 handles wired or wireless data transmission and reception to and from a particular device. The interface unit 450 receives data (captured image data and voice data) from the device through a specified communication interface and sends the received data to the control unit 470. The interface unit 450 sends data (captured image data, multimedia data and voice data) to the device through the specified communication interface under the control of the control unit 470.

According to design, the mobile terminal 100 may have multiple interface units supporting different wired and wireless communication schemes. The interface unit 450 may include a wireless transceiver module based on Bluetooth, IrDA, UWB or ZigBee technology, or a wired transceiver module based on a data connector or USB, FireWire or i.Link serial bus technology.

The camera module 460 captures the image of a target object under the control of the control unit 470, and sends the captured image data to the display unit 420 and/or the control unit 470. The camera module 460 may include a lens (not shown) receiving light, an image sensor (not shown) converting the light received by the lens into an electrical signal, and a signal processor (not shown) converting the electrical signal from the image sensor into digital data. The image sensor may be a Charge-Coupled Device (CCD) sensor or a Complementary Metal Oxide Semiconductor (CMOS) sensor. The image sensor and the signal processor may be realized as a single entity or as separate entities. In particular, when the mobile terminal 100 operates as a webcam, image data captured by the camera module 460 may be sent to the interface unit 450 under the control of the control unit 470.

The control unit 470 controls the overall operation of the mobile terminal 100, and controls signal exchange between the internal components thereof. The control unit 470 controls signal exchange between the input unit 410, display unit 420, audio processing unit 430, storage unit 440, interface unit 450, and camera module 460.

In particular, when the mobile terminal 100 operates as a webcam, the control unit 470 controls data transmission and reception through the interface unit 450. When the mobile terminal 100 operates as a webcam, the control unit 470 controls activation of webcam mode operation, and determines the operating mode for communication with the connected device according to settings in webcam mode operation.

When the operating mode is the capture mode, the control unit 470 controls the camera module 460 to capture image data, and controls the interface unit 450 to transmit the captured image data to the device. When the operating mode is the multimedia mode, the control unit 470 turns off the camera module 460 or directs the output of the camera module 460 to the storage unit 440, and controls the interface unit 450 to transmit multimedia data extracted from the storage unit 440 to the device.

The control unit 470 controls mode change between the capture mode and the multimedia mode. The control unit 470 may control output of data received from the device (captured image data, multimedia data and voice data). The control unit 470 may control operation of the microphone MIC as an input means for webcam communication, and control operation of the speaker SPK as an output means for webcam communication.

The control unit 470 controls processing of multimedia data extracted from the storage unit 440 or processing of image data captured by the camera module 460. To achieve this, the control unit 470 includes a data converter 480.

The data converter 480 may include a codec. The codec may include a data codec for processing image data such as captured data and multimedia data, and an audio codec for processing audio data such as a voice signal. The data converter 480 may encode image data to be sent to the device using the data codec, and decode audio data from the device using the audio codec.

The data converter 480 may process image data such as captured image data from the camera module 460 or multimedia data extracted from the storage unit 440 in units of frames to produce frame image data. In the multimedia mode, the data converter 480 may decode extracted multimedia data to play back the decoded multimedia data, and re-encode the decoded multimedia data and send the re-encoded multimedia data in a streaming format to the interface unit 450. The data converter 480 may buffer the multimedia data being played back using the storage unit 440, encode the buffered multimedia data into transmit data suitable for transmission, and send the transmit data to the interface unit 450.

The data converter 480 may compress image data in a preset format, and decompress compressed image data to recover original image data. The data converter 480 may include data codecs such as a JPEG codec, MPEG4 codec and wavelet codec.

As described above, the control unit 470 decodes multimedia data or captured image data and re-encodes the decoded data into transmit data, and controls the interface unit 450 to send the transmit data to the device.

The control unit 470 controls a data transmission path to the interface unit 450 according to the operating mode. That is, in the capture mode, the control unit 470 establishes a data path linking the camera module 460 and the interface unit 450 and controls transmission of captured image data. In the multimedia mode, the control unit 470 establishes a data path linking the storage unit 440 and the interface unit 450 and controls transmission of multimedia data.

These control operations of the control unit 470 may be implemented as software programs. As described in connection with FIGS. 1 to 4, the control unit 470 may control the overall operation required for the present invention.

The configuration of the mobile terminal 100 depicted in FIG. 4 is a simplified one for the purpose of description. However, the mobile terminal 100 is not necessarily limited by such a configuration.

The mobile terminal 100 may further include a baseband module and a radio frequency unit (not shown) to receive a mobile communication service. One or both of the control unit 470 and the radio frequency unit may include a baseband module.

Although not shown in FIG. 4, according to design, the mobile terminal 100 may further include a short range communication module for short range communication, an Internet communication module for connecting to an Internet Protocol network, and a digital broadcast reception module for receiving and reproducing mobile broadcasts. Given the trend towards digital convergence, it should be apparent to those skilled in the art that the mobile terminal 100 may further include a unit comparable to (other than) the above-described units, and a unit may be removed or replaced by another unit.

The mobile terminal 100 of the present invention may be any information and communication terminal having a camera module and an interface unit for connecting an external device, such as a mobile communication terminal supporting a communication protocol for a communication system, a Portable Multimedia Player (PMP), a digital broadcast receiver, a Personal Digital Assistant (PDA), a music player like an MP3 player, a portable game console, or a smart phone.

In accordance with an exemplary embodiment of the present invention, a mode change in the mobile terminal 100 may be triggered by a microphone or a motion sensor. For example, mode change may be triggered by voice recognition or motion recognition.

Next, a description is given of data communication in a video chat system using the mobile terminal 100.

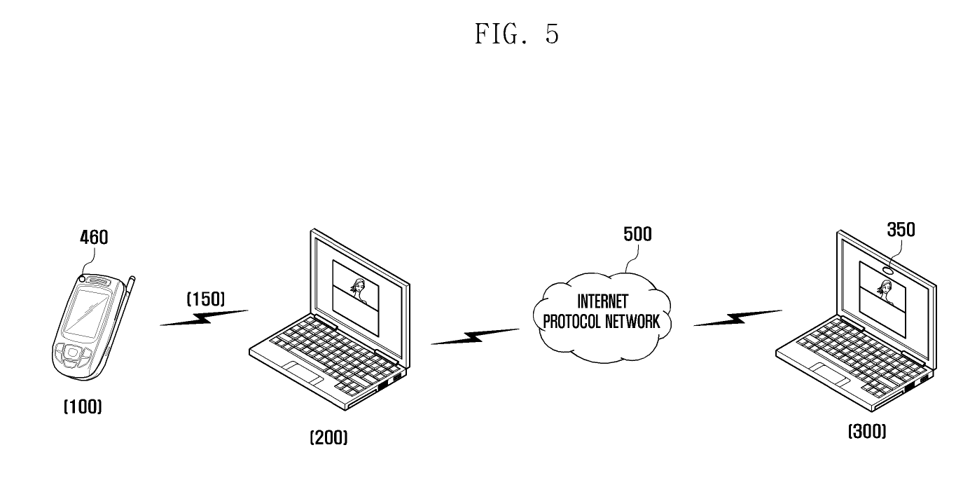

FIG. 5 illustrates a webcam communication system using the mobile terminal 100 according to an exemplary embodiment of the present invention.

Referring to FIG. 5, the video chat system of the present invention may include a mobile terminal 100 acting as a webcam for webcam communication, a first device 200 connected to the mobile terminal 100 through a wired or wireless personal area network 150 supporting a preset communication interface for webcam communication, and a second device 300 connected to the first device 200 through an Internet Protocol network 500 and running a webcam application to communicate with the first device 200.

In FIG. 5, the first device 200 exemplarily uses the mobile terminal 100 as a webcam, and the second device 300 uses a built-in webcam 350. If the second device 300 does not include a built-in webcam, it may use another mobile terminal as a webcam or a separate webcam. The first device 200 and the second device 300 may communicate with each other through the Internet Protocol network 500 using agreed upon webcam applications, such as a messenger application.

Each of the first user of the first device 200 and the second user of the second device 300 may run a webcam application to perform a login and authentication procedure for accessing the Internet Protocol network 500 and to initiate a webcam connection for a webcam communication service.

Thereafter, the first user and second user may capture image data using their webcams. That is, an image of the first user may be captured by the camera module 460 of the mobile terminal 100 connected to the first device 200, and an image of the second user may be captured by the webcam 350 of the second device 300.

The mobile terminal 100 may activate webcam mode operation upon connection to the first device 200 or upon reception of a user request after connection to the first device 200. Upon activation of webcam mode operation, the mobile terminal 100 enters the capture mode and transmits image data captured by the camera module 460 to the first device 200 through the personal area network 150. The first device 200 receives the captured image data from the mobile terminal 100 and transmits the captured image data to the second device 300 through the Internet Protocol network 500. In return, the second device 300 transmits image data captured by the webcam 350 to the first device 200 through the Internet Protocol network 500. The first device 200 may display captured image data received from the second device 300 on its display means, and the second device 300 may display captured image data received from the first device 200 on its display means. The first device 200 may send and receive captured image data, voice data, and text data to and from the second device 300 through the Internet Protocol network 500.

Later, during webcam communication, the first user of the first device 200 may initiate a mode change from the capture mode to the multimedia mode by setting an option of the webcam application or controlling the function of the mobile terminal 100.

When a mode change signal is received, the mobile terminal 100 transitions to the multimedia mode and checks the acquisition scheme for multimedia data. When the acquisition scheme is set to “default”, the mobile terminal 100 extracts multimedia data that is pre-specified by the user from the storage unit 440 (not shown in FIG. 5). When the acquisition scheme is set to “random”, the mobile terminal 100 extracts multimedia data that is randomly selected from the storage unit 440. When the acquisition scheme is set to “selection”, the mobile terminal 100 extracts multimedia data that is explicitly selected by the user through a selection procedure from the storage unit 440.

The mobile terminal 100 converts the extracted multimedia data in a format suitable for the agreed upon communication interface, and sends the converted multimedia data to the first device 200 through the personal area network 150. When transitioning to the multimedia mode, the mobile terminal 100 may turn off the camera module 460 and redirect the data path from the camera module 460 to the storage unit 440. The mobile terminal 100 may use a portion of the storage unit 440 as a buffer temporarily storing the multimedia data being sent to the first device 200.

The first device 200 receives the multimedia data from the mobile terminal 100 and forwards the same to the second device 300 through the Internet Protocol network 500. The second device 300 provides the multimedia data (instead of image data from the camera module) to the second user during webcam communication. The multimedia data may, for example, be photographs or moving images. The second device 300 may store the received multimedia data in its storage means according to a request of the second user or preset settings.

When the multimedia data to be sent is static data such as a photograph, the mobile terminal 100 may send the multimedia data in a lump to the first device 200. The first device 200 forwards the multimedia data to the second device 300, and the second device 300 may constantly display the multimedia data on its display means.

When the multimedia data to be sent is dynamic data such as a moving image, the mobile terminal 100 may both play back the multimedia data and also send the multimedia data to the first device 200 in a streaming format. The first device 200 receives and buffers the streamed multimedia data, and transmits the buffered multimedia data to the second device 300 in a First In First Out (FIFO) manner. The second device 300 displays the multimedia data on its display means. Hence, the first user and the second user may share moving image data during webcam communication and enjoy the same multimedia service, similar to the experience of watching a movie with someone.

When playback of the multimedia data is ended, the mobile terminal 100 may provide a cover image of the multimedia data to the first device 200, or may automatically transition to the capture mode and send image data captured by the camera module 460 to the first device 200.

As apparent from the above description, the present invention provides a data communication method and system using a mobile terminal that enable users to exchange various multimedia data during webcam communication, overcoming limitations of existing webcam communication in which users communicate with each other while looking at each other's face. Hence, it is possible to extend usability of webcam communication using a mobile terminal and to enhance user convenience in webcam communication.

According to an exemplary embodiment of the present invention, using webcam communication, playable multimedia data stored in a mobile terminal may be sent to a counterpart device through the Web or Internet, and the multimedia data can be shared. Here, multimedia data may include moving images, photographs, music data, broadcast data, menu data, mail data and message data.

According to an exemplary embodiment of the present invention, multimedia data stored in the mobile terminal may be sent during webcam communication. Hence, it is possible to extend usability of a webcam communication service using a mobile terminal as a webcam. Users of mobile terminals may send and receive multimedia data stored in their mobile terminals during webcam communication. Hence, various multimedia data can be shared between mobile terminals through webcam communication. In the present invention, during webcam communication, the mobile terminal may make a mode change between the capture mode in which captured image data is transmitted and the multimedia mode in which stored multimedia data is transmitted. Hence, the users may use webcam communication in various manners.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A data communication method using a mobile terminal, the method comprising:
activating a webcam mode operation;
identifying a preset operating mode during the webcam mode operation, the preset operating mode being selected from a plurality of operating modes comprising a multimedia mode and a capture mode; and
when the preset operating mode is the multimedia mode, extracting multimedia data according to a predetermined acquisition scheme and
transmitting the extracted multimedia data to a connected device through a pre-specified interface.

2. The method of claim 1, wherein the transmitting of the extracted multimedia data comprises:
decoding and playing back the multimedia data on the mobile terminal;
encoding the multimedia data being played back into transmit data; and
transmitting the transmit data to the connected device.

3. The method of claim 2, wherein the encoding of the multimedia data being played back comprises:
buffering the multimedia data being played back; and
encoding the buffered multimedia data into transmit data in a format suitable for the specified interface.

4. The method of claim 2, wherein the extracting of the multimedia data comprises:
extracting, when the acquisition scheme is a default scheme, predetermined multimedia data from among stored multimedia data;
extracting, when the acquisition scheme is a random scheme, multimedia data randomly selected from among stored multimedia data; and
extracting, when the acquisition scheme is a selection scheme, multimedia data that is explicitly selected through a selection procedure from among stored multimedia data.

5. The method of claim 1, further comprising:
capturing, when the operating mode is the capture mode, image data using a camera module, and transmitting the captured image data to the connected device; and
stopping, when a mode change is made from the capture mode to the multimedia mode, the image data capture, and transmitting the multimedia data extracted according to the acquisition scheme to the device.

6. The method of claim 1, further comprising, when a mode change is made from the capture mode to the multimedia mode:
transmitting the multimedia data extracted according to the acquisition scheme to the device; and
directing captured image data from the webcam to a storage unit.

7. The method of claim 1, further comprising changing the operating mode selected from the plurality of operating modes in accordance with a mode change signal.

8. The method of claim 7, wherein the mode change signal is generated by a user manipulation of the mobile terminal or an application.

9. The method of claim 7, wherein the mode change signal is generated in response to a trigger input detected by a microphone or motion sensor.

10. The method of claim 1, further comprising:
when the mobile terminal finishes transmitting the extracted multimedia data to the connected device, changing the operating mode to the capture mode.

11. The method of claim 5, further comprising performing, when a mode change is made from the capture mode to the multimedia mode, a data path switching from a data path for a captured image data transmission to a data path for a multimedia data transmission.

12. A mobile terminal comprising:
a camera module for capturing image data in a webcam mode operation;
a storage unit for storing multimedia data and mode information for the webcam mode operation;
an interface unit for transmitting one of captured image data using a data path from the camera module and multimedia data using a data path from the storage unit to an external device; and
a control unit for controlling a process of activating the webcam mode operation, for identifying an operating mode during the webcam mode operation, the operating mode being selected from a plurality of operating modes comprising a capture mode and a multimedia mode, for setting up, when the operating mode is the multimedia mode, a data path from the storage unit, and for transmitting multimedia data stored in the storage unit to the external device through the interface unit.

13. The mobile terminal of claim 12, wherein the control unit controls a process of decoding and playing back the multimedia data, encoding the multimedia data being played back into transmit data, and transmitting the transmit data to the external device through the interface unit.

14. The mobile terminal of claim 13, wherein the control unit buffers the multimedia data being played back using the storage unit and encodes the buffered multimedia data into transmit data.

15. The mobile terminal of claim 13, wherein the control unit comprises a data converter for decoding and playing back the multimedia data, for buffering the multimedia data being played back, for encoding the buffered multimedia data into transmit data in a format suitable for a specified interface, and for outputting the transmit data to the interface unit in a streaming fashion.

16. The mobile terminal of claim 15, wherein the specified interface comprises at least one of a wired interface between the mobile terminal and the external device and a wireless interface therebetween.

17. The mobile terminal of claim 15, wherein when the operating mode is the multimedia mode, the control unit determines an acquisition scheme for multimedia data and controls an extraction of multimedia data according to the determined acquisition scheme.

18. The mobile terminal of claim 17, wherein the control unit controls a process of
extracting predetermined multimedia data when the acquisition scheme is a default scheme,
extracting randomly selected multimedia data when the acquisition scheme is a random scheme, and
extracting multimedia data that is explicitly selected through a selection procedure when the acquisition scheme is a selection scheme.

19. A webcam communication system comprising:
a mobile terminal, comprising a camera module, for transmitting one of image data captured by the camera module and stored multimedia data through a specified interface according to an identified operating mode selected from a plurality of operating modes comprising a multimedia mode and a capture mode during a webcam mode operation;
a first device, connected to the mobile terminal through the specified interface, for forwarding the captured image data or multimedia data received from the mobile terminal; and
a second device for performing webcam communication with the first device through a network, for receiving the captured image data or multimedia data from the first device, and for providing the received data to a user thereof,
wherein the mobile terminal may change the operating mode among the plurality of operating modes.

20. The webcam communication system of claim 19, wherein the specified interface is at least one of a wired interface between the mobile terminal and the first device and a wireless interface therebetween.
